(19) United States
(12) Patent Application Publication
(10) Pub. No.: US 2002/0133562 A1
(43) Pub. Date: Sep. 19, 2002

(54) System and method for operating internet-based events

(76) Inventors: Scott G. Newnam, Cambridge, MA (US); Izet Fraanje, Cambridge, MA (US); Martin J. Cribbins, Boston, MA (US); Andrew J. Borleske, Charlestown, MA (US); Douglas T. Neumann, Somerville, MA (US)

Correspondence Address: HALE AND DORR, LLP, 60 STATE STREET, BOSTON, MA, 02109

(21) Appl. No.: 09/804,815

(22) Filed: Mar. 13, 2001

(51) Int. Cl. G06F 15/16; G06F 15/167

(52) U.S. Cl. 709/216; 709/203

(57) ABSTRACT

In interactive Internet-based system and method provides a number of components that can be used to provide interactivity, including cat, polling, and trivia functionalities, particularly for use in enhancing other events, such as television programs.

### BACKGROUND OF THE INVENTION

The present invention relates to a system and method for producing interactive multi-user events.

Interactive entertainment has existed for several years in the forms of video games and computer games. Using the Internet, users can compete in multi-player games using computers and Web-enabled consoles. The fast penetration of the Internet into the majority of the U.S. households has provided a sudden increase of interactive content and the ability for end-users to interact. It has also promoted the popularity of interactive Internet programming for education and entertainment.

Interactive Internet programming is applicable in a variety of markets, such as the interactive entertainment market. Currently, interactive entertainment is delivered either via the TV with side-by-side personal computer (“enhanced broadcasting”) or the personal computer alone (“online interactive entertainment”). Enhanced broadcasting, providing data that supplements a video broadcast, enables consumers to purchase products or request product information (e.g., literature, coupons, or sample merchandise), access additional information (e.g., news, sports, or weather), or otherwise interact with television programming (e.g., TV game shows or polls).

Due to the dominant penetration of the personal computer, the majority of interactive entertainment is delivered via the personal computer. As the penetration of broadband Internet connectivity increases, and platform development continues, interactive entertainment may migrate to the TV with a web-enabled television, a set-top box ,or an Internet-connected console. Additionally, some interactive programming, such as simple game applications, will be available on handheld devices via the Wireless Application Protocol (WAP) and on future Internet devices.

The likely convergence of television and the Internet, and the growing demand for interactive entertainment, has created a need for interactive programming that encourages the evolution of entertainment from passive television to the types of interactive entertainment that will be possible once broadband Internet access and digital television are ubiquitous.

In recent years, television networks have offered enhanced television programs and events. These offerings allow users to request additional information and to interact with the programming.

### SUMMARY OF THE INVENTION

The overall system of the present invention includes a user-based hardware device with a controller, client software on the hardware device, server-based interactive components, and a technical director for interacting with the server and the client via the server. The client preferably has three levels of software: core or basic control software, content based on the type of event, content for a specific instance of an event. For an interactive television application, the type of event and instance of that event would be a program and specific episodes, respectively.

The interactive components can include chat functionality, whereby users can discuss program and event content, use buddy lists to create private chat rooms, and use instant messaging. These features are particularly suited to interactive games whereby users can build rivalry with, encourage, or goad each other, to raise the level of excitement and competitiveness of head-to-head match-ups. The system can perform other interactive processing to enable users to influence and drive content changes in real time. For example, the present invention can support the following other types of interactive processing: (i) real-time, interactive question-and-answer-based games (e.g., trivia) wherein a multitude of users compete against each other in real time; (ii) real-time voting and polling wherein audience members vote to determine broadcast content (e.g., choose-your-own-adventure) or provide their opinion on broadcast content (e.g., issues polling) and (iii) instantaneous reporting of game, voting, and polling results.

The producer of the interactive event can control the presentation of animated movies, audio, video streams, participant polls, trivia questions and answers, and messages through the technical director. During the event, participants can participate in chat rooms and send messages back to the host producer. The producer can change the content or generate new content based on the questions and comments from the users or the course of a live event.

The client (user) software system (i) provides premium functionality, (ii) can be used on different types of hardware platforms, (iii) is presentation layer independent, (iv) contains a messaging library that enables synchronization, and (v) is efficiently leveraged for multiple interactive events. The client used in the present invention has three layers. The first layer has several components that each provide various types of functionality. These components can be utilized with various hardware platforms (personal computers, Macintosh, set-top box, digital television, web console, handheld WAP devices, etc.) and various types of presentation software (Shockwave, Flash, etc.). The second layer has scripts, graphics and other data specific to the producer's program (e.g., a weekly show). The third layer has data specific to an event available at a specific time on a specific date (e.g., an episode of a program). This content can be made to expire to minimize storage space and protect copyrighted materials. A user participating in two different programs can utilize one version of the first layer for both programs, two versions of the second layer, and during the particular event, will utilize software from the third layer.

The system enables large television-sized audiences, i.e., thousands or more remote people, via Internet infrastructure and not on local networks to interact with each other by using a messaging code that tells the user interface when and how to present the content.

The system of the present invention (i) allows users to impact the programming in real-time; (ii) allows users to communicate with a producer of the programming; (iii) allows users to interact with each other; (iv) is scalable to a television-sized audience; (v) provides users with a similar experience regardless of modem speed; and (vi) maintains synchronization among users. The system of the present invention thus provides an improved medium for interactive entertainment by enabling consumers to interact with each other and to impact the course of the event.

The system of the present invention can scale to accommodate large audiences by (i) maintaining the state of the event across multiple servers; and (ii) utilizing global software and hardware load balancing that guarantees each user a spot in the event while distributing the load across the network of servers.

The present invention synchronizes the ‘interactive content’ to other content such as a television broadcast. The system provides a mechanism to generate real-time Internet content that can be synchronized to the TV broadcast and synchronize content already present on the end-users system with the TV broadcast.

The present invention enables a rich media experience for all users regardless of connection speed. By providing a rich media solution for narrowband users, the present invention enables the incorporation of sound and video to enhance the interactive entertainment. For example, rich media can be used in (i) game questions: users are questioned on video clips, (ii) advertising: sound and video enable more compelling advertising messaging, or (iii) supplementary content: behind-the-scenes footage, star interviews, etc. The present invention delivers the same rich media experience to users with high or low Internet connection speeds by using a messaging system to send message types from the event servers to the user interface which controls the delivery/ display of existing rich media content.

The invention can be used to provide advertising and e-commerce. The system's capacity to support advertising and e-commerce encourages additional commerce. The present invention enables advertising that unites the best of television and Internet models by uniting interactivity with broad reach. Users can request information on demand, enabling advertisers to create powerful, customized messages that influence consumer-purchasing behavior.

All the interactive functionality/content such as polls, trivia, chat, audio, and advertisements can be synchronized with each other. The present invention includes a mechanism to, for example, (i) highlight a picture of the person whose voice is currently in the audio stream, (ii) play a video clip related to the trivia question currently being displayed, or (iii) display a graphic related to the subject of a poll.

Other features and advantages will become apparent from the following detailed description, drawings, and claims.

### BRIEF DESCRIPTION OF THE DRAWINGS

FIG. 1. is a high level block diagram of the system showing the client, server system, and tech director.

FIG. 2. is a block diagram of the server system of the present invention.

FIG. 3 shows an example of real-time processing of a poll by the server system.

FIG. 4 shows an example of real-time processing of a trivia question by the server system.

FIG. 5. shows an example of the display of an advertisement.

FIG. 6. shows the process of submitting a question to the producer.

FIG. 7 is a flow chart relating to initialization.

### DETAILED DESCRIPTION

The system of the present invention creates the basis for true interactive on-line programming. This programming can be Web-only events or it can be synchronized with other activities, such as television programs, to enhance the programming content. The system provides a number of forms of interactive processing, chat, and e-commerce. Content can be brought down to the client ahead of time and accessed through messages, or content can be created and delivered on the fly as a program is being broadcast. Participants can all be in-sync regardless of differences in their respective modem speeds. When used with television or some other activity, the present invention preferably operates independently of the television signal, although the system allows broadcasters to provide content that is related to the television program being broadcast, such as trivia questions about actors in a movie that appears at the same time.

A content provider, such as a television network, can broadcast television programming to a television via cable, satellite, over-the-air, or other means. Before that telecast, the system allows the broadcaster to develop information and to send that information to a user's hardware device using the Internet infrastructure with messages preferably sent using available communication protocol.

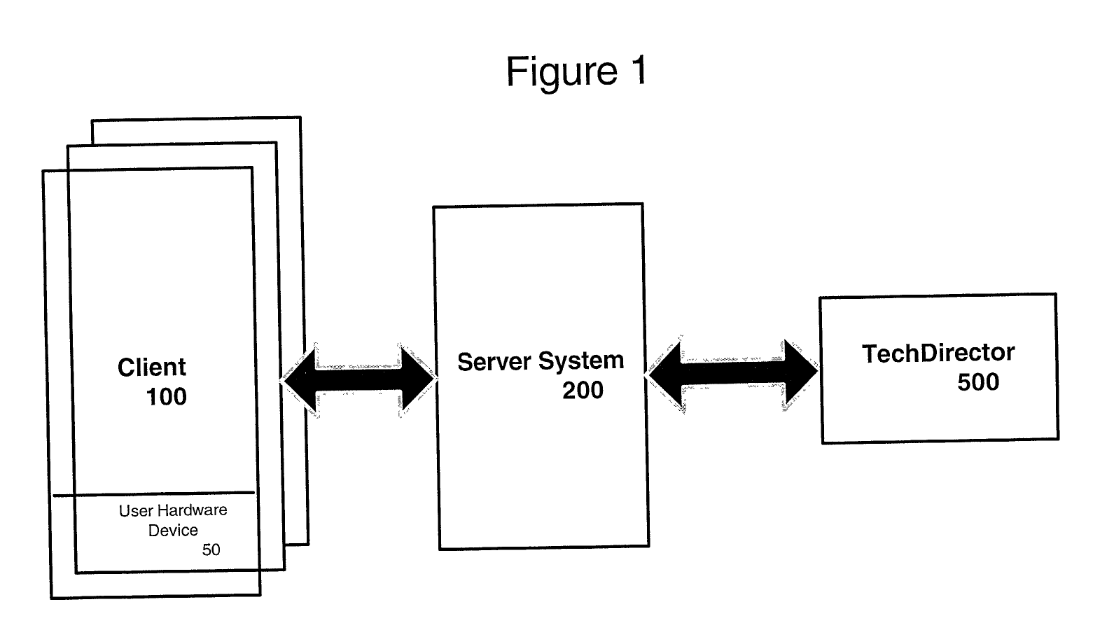

FIG. 1 shows components of an embodiment of the present invention. The system includes a user hardware device 50, a client 100 on the hardware device 50, a remote server system 200, and a technical director 500. The user hardware device 50 is a processor that can be a personal computer (meant here broadly and regardless of the specific operating system), a set-top (cable) box, a digital television, a Web enabled console, a handheld device connected to the Internet via Wireless Application Protocol, or any other processing device with an interface for connection to the Internet. The client 100 is the software, preferably a thin piece of software, that resides on the user hardware device 50 and that is responsible for communication with server system 200.

The system allows multiple clients 100 to simultaneously interact with server system 200. Client 100 can interpret messages and content sent by server system 200. The client 100 can be part of a plug-in to a web browser or a stand-alone application. It has multiple objects that have different responsibilities such as content management, messaging, chat, and multi-media display and streaming.

The technical director 500 is a software interface (e.g., a web page) on a computer and resides between a producer of the event, such as a television broadcaster, and the system. The technical director 500 allows users to impact the content of the event in real-time by enabling the producer to change the content based on input from the users. The technical director 500 can also, for example, receive, display, and allow the producer to select questions posed to the producer or event's host or comments made by the user. The producer can respond to the questions or comments through the real-time creation of event content. The new content could be multi-media content distributed by a broadcaster or content created by the technical director 500. For example, the technical director 500 allows producers to generate real-time content (e.g., a real-time fun fact or poll) and to trigger the display of such content on the client 100 utilizing the server system 200.

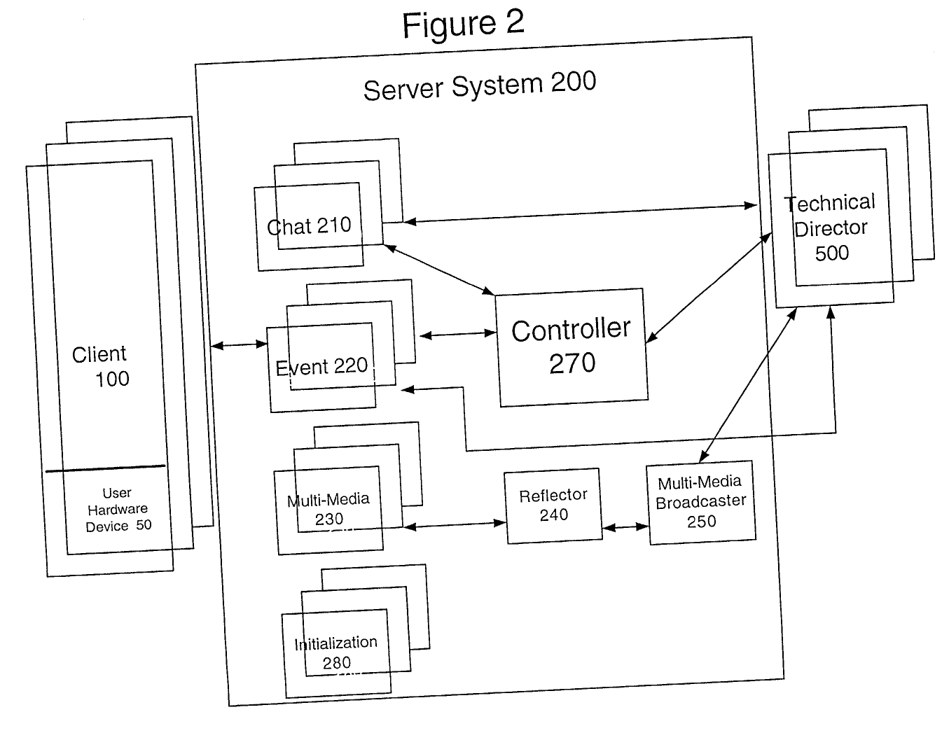

As shown in FIG. 2, server system 200 of the present invention has multiple components. A chat component 210, allows the users to write messages to, and read messages from, each other during an event. The chat component 210 is responsible for managing the information exchange between users. The user enters information using hardware device 50. The client 100 processes the entry and provides the information to the server system 200; the chat component 210 publishes this information out to the other clients 100 participating in the event or participating in the chat aspect of the event. The chat component 210 can also filter certain language, such as potentially offensive language, allow users to enter different chat rooms, allow users to chat with specific users that are on their “buddy lists” based on other users' personal identifiers, and provide other features that can enhance this chat feature. As can be seen from FIG. 2, the server system 200 can contain multiple chat components 210.

An event component 220 is responsible for interactive processing for activities such as games, polls, and fun facts. Event component 220 initiates communication with the client 100 to trigger display of content through different types of messages. The client 100 and event component 220 utilize a messaging code to minimize data transfer. For example, if the event component 220 sends the following message: “2,Who holds the record for most homeruns in a season?, Micky Mantle, Babe Ruth, Mark McGwire, Sammy Sosa”, the client 100 will recognize the message as a message type 2 (in this case, meaning trivia question) and display the text “Who holds the record for most homeruns in a season?” as a trivia question and display the four choices that follow as possible answers. Alternatively, if the event component 220 sends the message “3,Who is the best hitter of all time?, Micky Mantel, Babe Ruth, Mark McGwire”, the client 100 will recognize it as message type 3 (in this case, a poll) and display the information as a poll, such as with radio buttons. The client displays these types of interactivity in a desired way, and with captions in the boxes in which they are displayed, based on the message type received.

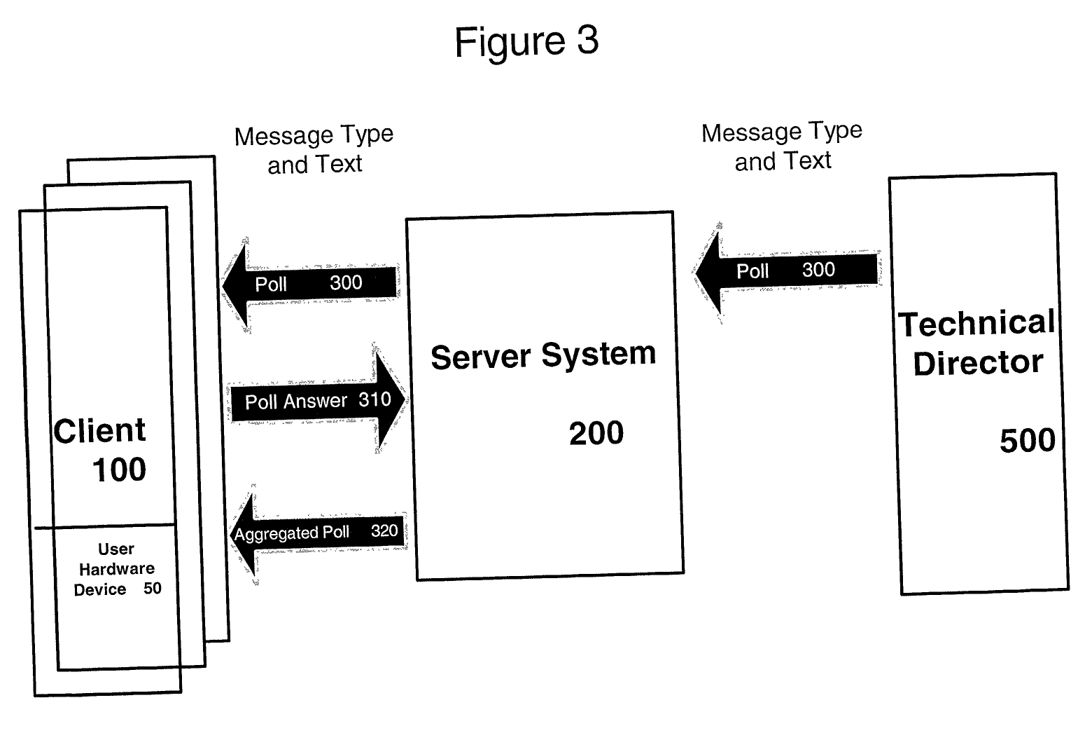

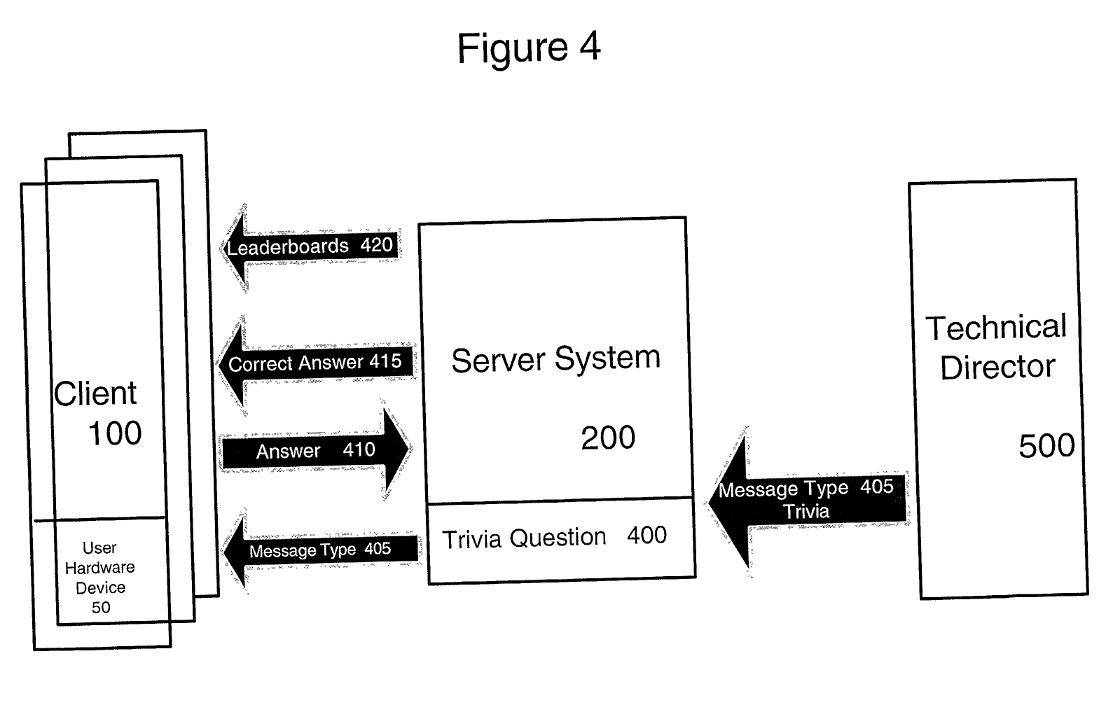

The client 100 can be set to send back the answer to the trivia question or poll based on a defined occurrence, such as after a predetermined amount of time, when the user inputs the answer, or when the producer requests the results using the technical director 500. In all cases, the client 100 sends the message back to the event component 220. The event component 220 receives, aggregates and sends the results to the controller (see also FIG. 3 and FIG. 4). In most cases in which information is sent back as a response, the time for responding is short relative to the event, e.g., 60 seconds or 30 seconds or less. This allows the answer or poll result, for example, to be broadcast to all users without long waiting times. As shown in FIG. 2, the server system 200 can include multiple event components 220.

A multimedia component 230 is in charge of the broadcast and distribution of multimedia, such as audio and video, and interacts with a broadcaster 250 and a reflector 240. The broadcaster 250 is an encoding device that creates the appropriately formatted multimedia and distributes it to multimedia components 230 through the reflector 240. The controller 270 and the reflector 240 can also be executed as one component. As shown in FIG. 2, the server system 200 can include multiple multimedia components 230.

The controller 270 coordinates among the different components in server system 200, the multiple instances of the same component (e.g. multiple event components), and the communication between the components and the technical director 500. The controller 270 synchronizes the other server system components, which in turn manage the synchronization of all the clients 100. The controller 270 receives messages from the technical director 500, and distributes the messages to the applicable server system components, which distribute the messages to the clients 100.

The initialization component 280 prepares the end-users system for programming participation. It initializes the user's computer by installing or enabling the client 100 by downloading over the Internet infrastructure. The first time this happens, the user may be required to enter an identification and password.

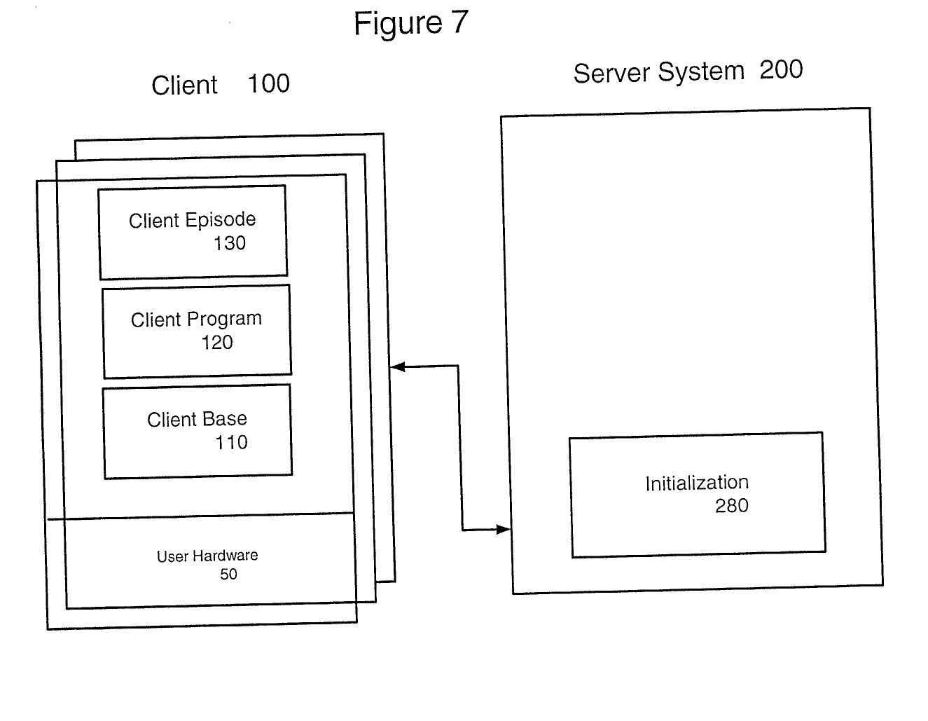

Referring also to FIG. 7, the client 100 has three components: client base 110, client program 120, and client episode 130. These three components together allow the user to participate in an event. However, when a user participates in a subsequent event with the same user hardware device 50, the initialization component 280 only downloads the client components that are not present already on the user hardware device 50. For a new episode of a television show, these components would include a new client episode, and need not include the client base or client program, but could include updates or enhancements to the client base and client program.

In another embodiment, the server system 200 can directly interact with the user device 50 without the client 100 and the three specific components shown in FIG. 7. In another implementation, user device 50 has code similar to client base 110 already resident on the system before participating in any programming related to the system of the present invention, to which the server system 200 can link. For example, software of the base software type may be included in a device as part of its operating system. In another implementation of the system of the present invention, the client program 120 can be ‘flashed’ down for each episode depending on the type of user hardware device 50, rather than being initialized.

When the system of the present invention is used to enhance television broadcasting content, the first time that the user uses the system, the user downloads the client base, the client program for the particular program being enhanced, and the client episode for the next episode of the program. The base software includes code that manages the system and interacts with the components, including providing and displaying chat messages and handling different message types for display to the user.

The program content can include images that will be displayed with a particular program whenever that program is enhanced with the system of the present invention. For example, this content can include a background display to be shown on the monitor and can include other information, such as biographical information about actors, that does not change from episode to episode. This content need not be downloaded for each episode (although enhancements and updates typically would be).

The episode content that is downloaded can include content relating to the specific episode of the program being shown and can include, in advance, certain fun facts, trivia questions, or other items that can be accessed. In a cooking show, for example, the episode content could be recipes that will be made, and can include additional recipes to further enhance the televised content. The episode content can include a time-out feature such that the content is essentially deleted at the end of the episode. If a user wants to watch a future episode, the user can download the relevant episode content.

The terms program and episode should be broadly understood to mean any type of event and episode or instance of that event. In addition, there could be one-time events in which the client program and client episode are essentially a single client piece.

FIG. 3 illustrates in detail the flow of interactive content through the present invention using a poll as an example. The technical director 500 sends a poll 300, including a message type and text for the poll 300 to the server system 200. The relevant components of the server system 200 send out the poll 300 to the client 100. The client 100 interprets the message type poll and displays the text as a poll on the user hardware device 50. The user device 50 accepts a poll answer 310 by the user, and returns the poll answer 310 to the server system. The client 100 can be set to send the poll answer 310 when the client receives one of a number of possible triggers, such as a message from the technical director 500 via server system 200, an input from the user through the user hardware device 50, or automatically after a specified time, preferably on the order of 30 seconds or less. The server system 200 processes and aggregates the poll results. After this processing (only a matter of seconds), the aggregated poll results 320 are sent back out to the client 100 and displayed on the user hardware device 50.

FIG. 4 shows another example of interactive content flowing through the system of the present invention. A trivia question 400 can, for example, reside on the server system 200 or be provided from the technical director. If on the server, the technical director 500 can initiate the sending and the display of this trivia question 400 in real-time. This ability allows the producer to synchronize the display of the question with live multi-media content (e.g. an audio stream of the host reading the question or a video clip related to the question), and to synchronize with the program. The technical director 500 sends trivia message type 405 and the server system 200 then takes the trivia question 400 and sends it on to the client 100 along with the message type 405. The client 100 interprets message type trivia 405 and displays the text in trivia question 400 as a trivia question on the user hardware device 50.

The user selects an answer and the client 100 sends back the trivia answer 410 to the server system 200 when it receives one of a number of triggers, such as a message from the technical director 500, an input from the user through the user hardware device 50, or automatically after a specified time, preferably on the order of 30 seconds or less. The server system 200 processes the trivia responses 410 and determines if each response is correct or incorrect. The server system 200 sends back the score 415 indicating whether the answer was correct or incorrect and the time used to answer the question.

Alternatively, the correct answer can be sent with the trivia question 400, and the client 100 can determine if the response is correct based on previously downloaded information and then record the time for sending the results (correct or incorrect) and the time back to the server system 200. The system can display a running decrease in the value of the question based on the time it takes to respond—e.g., answering in 2 seconds may be worth one number of points, and in 8 seconds a reduced number of points. In either case, the server system 200 aggregates and records the results. The server system 200 can send out a message type indicating a leader board and the leader board text 420 to the client 100. The client 100 interprets the message type as a leader board 420 and displays the leader board text 455 showing the cumulative results of the trivia contest. The leaders can be shown based on user input names and shown to all users.

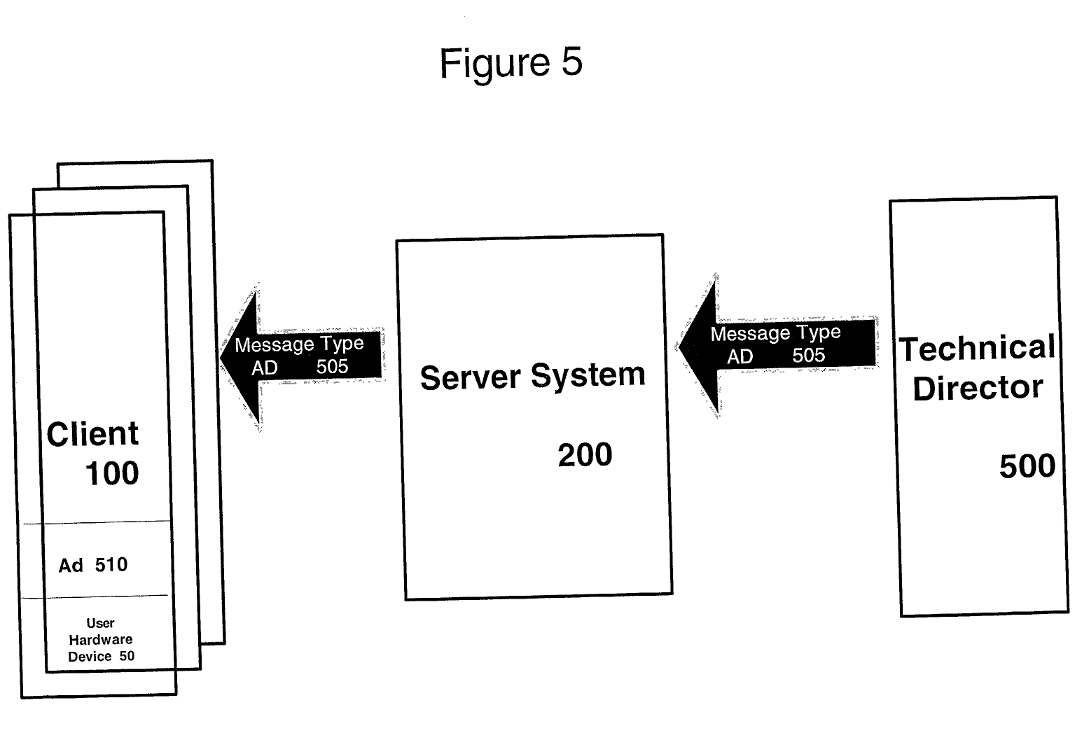

FIG. 5 gives an example of an advertisement trigger and display. As discussed relating to FIG. 2, the episode specific content can be brought down to the client 100 at the beginning of the event by the initialization component 280. An advertisement 510 (e.g., in the form of a graphic image like a banner ad) can be part of the episode specific content. This ad can thus already reside on the client 100 but is not displayed until triggered by a message type from the technical director 500 to display that particular ad. The technical director 500 sends message type ad 505. This message type is distributed by the server system 200 to all the clients 100 at the same time. Once the client 100 receives message type ad 505, the client causes the ad to be displayed. The ad can be a link to another web site if selected by the user, such as with a mouse or a remote control. In that case, a separate browser instance is opened while the user accesses the web site.

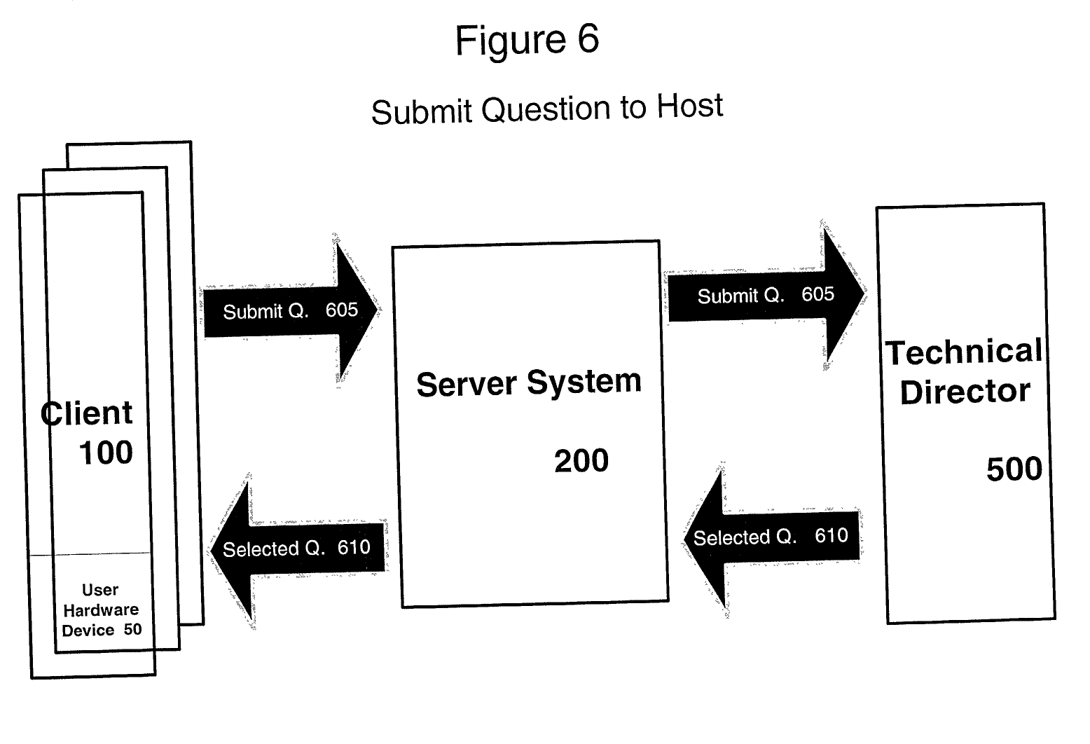

FIG. 6 shows another example of interactive processing of the present invention. The user can submit a question or comment to the host or producer. The client submits a question or comment to the host by entering the question or comment in the client 100 using the user hardware device 50. The client 100 sends the question or comment 605 through the server system 200 to the technical director 500. The person/system directing the technical director 500 (the producer) can select questions or comments 610 submitted by the users. The producer can convey the questions or comments to another host of the program or respond to the questions and comments using multi-media content or real-time generated fun facts or polls. The producer can also select the question or comment and send the selected question or comment 610 back to the client 100 through the server system 200 for display by the user hardware device 50.

The technical director 500 can thus send messages in different ways, such as a message type and message content, such as text, to be provided to the client for processing the message type and using the text; a message type that causes content in the server system to be provided to the client; or a message type that is provided to the server system 200 which is provided to the client for causing content already resident on the client to be displayed. As also indicated, the technical director can cause content to be displayed at predetermined times, or live and on the fly in response to questions or comments from users, or in response to something that is occurring during the programming.

In the case of scheduled information, a program may be divided into segments to be separated by commercials. The system can be used to program those segments which can then be initiated automatically or with human intervention when commercials end, as it is possible for the length of commercials between segments to be adjusted very close to the airing of the program.

The interactive functionality, such as polls, trivia, chat, audio, and advertisements, can be synchronized with each other. The present invention allows the system to highlight a picture of the person whose voice is currently in an audio stream, play a video clip related to the trivia question currently being displayed, or display a graphic related to the subject of a poll.

The client can be used on different types of hardware platforms and can be made presentation layer independent. Because of the way the client is downloaded in pieces and because content can be directly provided or reside and accessed through messaging, it is efficient in its use of memory space, and is efficiently leveraged for multiple interactive events. A user participating in two different programs can utilize one version of the first layer for both programs, two versions of the second layer, and during the particular event, will utilize software from the third layer.

The system of the present invention can scale to accommodate extremely large audiences by maintaining the state of the event across multiple servers; and utilizing global software and hardware load balancing that guarantees each user a spot in the event while distributing the load across the network of servers.

Having described embodiments of the present invention, it should be apparent that modifications can be made without departing from the scope of the appended claims, and without necessarily having all the features and advantages recited herein. For example, additional interactive components can be provided and a system need not include all of the components that are included here.

What is claimed is:

1. A methods for a user to interact with a server comprising:
receiving client software for operating on a user-based hardware device that has the ability to control a display, the client software including base software for causing information to be displayed on the display and including software responsive to multiple message types relating to different types of interactivity, program content particular to a certain type of event, and episode content particular to an episode of the event, the receiving of program content and episode content occurring by downloading before the beginning of an episode;
the client receiving from the server messages, each with one of a plurality of message types indicating one of a plurality of types of interactivity related to the episode of the event; and
the base software using the message type to cause to be displayed on the display content associated with that message type and in a form particular to the message type.

2. The method of claim 1, further comprising, for a next episode, downloading the episode content without again downloading the program content and without downloading the base software.

3. The method of claim 1, further comprising, for an episode of a different program, downloading the program content and the episode content without downloading the base software.

4. The method of claim 1, wherein the program content relates to a television program, and the episode content is for a particular episode of that television program.

5. The method of claim 1, wherein at least two of the types of interactivity include a question to which the user can respond.

6. The method of claim 5, wherein the types of interactivity include a trivia question and a poll.

7. The method of claim 1, wherein the message type indicates a trivia questions, and message includes text for the question, the base software being responsive to the message type for formatting the question as a trivia question and displaying the trivia question.

8. The method of claim 7, wherein the formatting further includes displaying a point count for the question that changes with time.

9. The method of claim 7, wherein the base software, responsive to a user entering an answer, causes the answer to be provided to the server to determine if it is correct.

10. The method of claim 7, wherein the wherein the base software, responsive to a user entering an answer, checks the answer against an answer stored as episode content.

11. The method of claim 7, wherein one of the client and server corrects the answer, the client receiving from the server and displaying a point total for multiple users interacting at the same time with the server.

12. The method of claim 1, wherein the client is presentation layer independent.

13. The method of claim 1, wherein the client operates with a particular type of presentation software.

14. The method of claim 1, further comprising sending messages to and receiving messages from other users via the server.

15. The method of claim 1, wherein the episode content includes an advertisement, the base software being responsive to a message type for causing the advertisement to be displayed.

16. The methods of claim 1, wherein the client is responsive to the receipt of a message type and audio and/or video information for synchronizing the audio and/or video information to the interactivity indicated by the message type.

17. A method for a server to interact with a user comprising:
providing client software to a user-based hardware device having the ability to control a display, the client software including:
base software for causing information to be displayed on the display,
program content particular to a certain type of event, and
episode content particular to a specific episode of the event;
the program content and episode content being downloaded before the beginning of an episode;
the server providing to the client messages, each with one of a plurality of message types indicating one of a plurality of types of interactivity related to the episode of the event so that the user can cause to be displayed on the display content associated with that message type.

18. The method of claim 17, further comprising, for a next episode, providing the episode content without again providing the program content and the base software.

19. The method of claim 17, further comprising, for an episode of a different program, providing the program content and the episode content without again providing the base software.

20. The method of claim 17, wherein the program content relates to a television program, and the episode content is for a particular episode of that television program.

21. The method of claim 17, wherein one of the types of interactivity include a question to which the user can respond, the message including a message type and a question.

22. The method of claim 21, wherein the types of interactivity include a trivia question and a poll.

23. The method of claim 21, wherein the server is responsive to the base software providing either an answer for correction or an indication that the answer was correct for providing to users point totals indicting points in response to the answers provided.

24. The method of claim 17, wherein the client is provided to be presentation layer independent.

25. The method of claim 17, wherein the client is provided and adapted to operate on a particular type of presentation software.

26. The method of claim 17, further comprising a technical director for managing the server and providing messages to and receiving messages from the server.

27. The method of claim 26, wherein the server provides messages from users to the technical director, wherein the technical director is staffed by an individual that can providing responses to users via the server.

28. The method of claim 26, wherein questions for responses are initiated from the technical director to the server, and thereafter to the users.

29. The method of claim 26, wherein the program is a television program, wherein the technical director provides content to the server for transmission to the users, the content being stored and timed to be received by the user in such a way that the content is synchronized to the television program to display content relevant to the program at that time.

30. The method of claim 29, wherein the content is stored in advance of being displayed and is timed to appear at selected times.

31. The method of claim 30, wherein the technical director receives content as a human input and provides that content on the fly as a supplement to the content stored in advance.

32. The method of claim 29, wherein the technical director receives content as a human input and provides that content on the fly to appear at a desired time such that it is relevant to the program at that time.

33. The method of claim 17, wherein the episode content includes an advertisement, the server sending a message type to indicate to the client that the client should cause the advertisement to be displayed.

34. The methods of claim 17, wherein the server provides audio and/or video information synchronized to textual messages to cause the textual messages to be displayed with the audio and/or video content.

35. The method of claim 17, where messages can be provided to thousands of users at the same time.

36. A system for interacting with users comprising:
a server having interface for connection to the Internet infrastructure to provide messages to users that have client software for receiving messages from the server;
a technical director for providing to the server different message types that indicate one of a number of types of interactivity with users, and for providing message content to the server, the message content relating to a specific episode of an interactive event, wherein the technical director can provide stored messages and message types for display at desired times during the event, and individually input information on the fly;
the server, responsive to messages and message types from the technical director, for providing such message types and message content to users.

37. The system of claim 36, wherein, in some instances, the technical director provides only a message type, and the server provides related content.

38. The system of claim 36, wherein, in some instances, the technical director provides only a message type, and the server provides the message type to the user, the message type indicting to the user that content previously stored by the user is to be displayed.

39. The system of claim 36, wherein, in some instances, the technical director provides a message type and the content to be provided.

40. The system of claim 36, wherein the server provides questions with a message type and maintains scores of users who answer questions, the server periodically providing a list of scores to the users.

41. The system of claim 36, wherein the technical director, responsive to individual input, responds to messages input by users and provided to the technical director via the server.

42. The method of claim 1, wherein the base software is downloaded through Internet infrastructure.

43. The method of claim 1, wherein the base software resides on the hardware device without being downloaded through Internet infrastructure.

44. The method of claim 17, wherein the base software is downloaded through Internet infrastructure.

45. The method of claim 17, wherein the base software resides on the hardware device without being downloaded through Internet infrastructure.
